(19) United States
(12) Patent Application Publication
(10) Pub. No.: US 2026/0186628 A1
(43) Pub. Date: Jul. 2, 2026

(54) GENERATIVE ARTIFICIAL INTELLIGENCE

(71) Applicant: Google LLC, Mountain View, CA (US)

(72) Inventor: Walter Alejandro Vulej, Mountain View, CA (US)

(21) Appl. No.: 18/858,873

(22) PCT Filed: Jul. 14, 2023
(86) PCT No.: PCT/US2023/027798

§ 371 Date: Oct. 22, 2024

(51) Int. Cl. G06F 3/0484; G06F 40/35

(52) U.S. Cl. CPC G06F 3/0484; G06F 40/35

(57) ABSTRACT

Methods, systems, and apparatus, including computer programs encoded on a computer storage medium, for generating digital components for a conversation between a user and an artificial intelligence (AI) system employing a language model. The method comprises receiving, as part of the conversation, an input message from the user, receiving, as part of the conversation, an output generated by the AI system in response to the input message and based on the language model, determining one or more keywords based on at least one of the input message and the output, generating one or more digital components based on the one or more keywords, determining that there is a pause in the output while the AI system continues to generate additional output, and incorporating the one or more digital components into the conversation at a location corresponding to the determined pause for display on a user interface.

### BACKGROUND

This specification relates to data processing and blending content from different domains into a combined visual presentation.

### SUMMARY

This specification describes techniques for generating digital components for a conversation between a user and an artificial intelligence (AI) system employing a language model. In general, one innovative aspect of the subject matter described in this specification can be embodied in methods that include the actions of receiving, as part of the conversation, an input message from the user, receiving, as part of the conversation, an output generated by the AI system in response to the input message and based on the language model, determining one or more keywords based on at least one of the input message and the output, generating one or more digital components based on the one or more keywords, determining that there is a pause in the output while the AI system continues to generate additional output, and incorporating the one or more digital components into the conversation at a location corresponding to the determined pause for display on a user interface.

These and other embodiments can each optionally include one or more of the following features. For example, in some implementations, generating the one or more digital components based on the one or more keywords further comprises sending the one or more keywords to a processing system, and receiving, from the processing system, the one or more digital components.

In some implementations, determining the one or more keywords based on at least one of the input message and the output comprises parsing the at least one of the input message and the output.

In some implementations, determining the one or more keywords is further based on one or more of: the input message, the output, one or more previously received input messages, one or more previously generated outputs, one or more previously received input messages from a previous conversation of the user, one or more previously generated outputs from a previous conversation of the user, one or more previously received input messages from one or more previous conversations of the user, one or more previously generated outputs from one or more previous conversations of the user, a profile of the user, personalization information associated with the user, a location of the user or of a client device used by the user, or one or more properties of the client device.

In some implementations, the output comprises a plurality of text items and wherein determining the one or more keywords comprises determining, for each text item in the plurality of text items, at least one keyword.

In some implementations, the processing system comprises one or more of a search engine, a digital component server, a reservation system, an assistant system that assists the user with tasks, or a chat bot.

In some implementations, the method further includes displaying, on the user interface, the conversation and the one or more digital components.

In some implementations, generating the one or more digital components based on the one or more keywords comprises separately generating each digital component of the one or more digital components based on at least a subset of the one or more keywords.

In some implementations, the method further includes selecting a subset of the one or more digital content items; and wherein incorporating the one or more digital components into the conversation comprises incorporating the subset of the one or more digital content items into the conversation.

In some implementations, selecting the subset of the one or more digital content items is based on a combination of one or more of: a measure of relevance of one or more of the input message, the output, one or more previously received input messages, one or more previously generated outputs, one or more previously received input messages from a previous conversation of the user, one or more previously generated outputs from a previous conversation of the user, one or more previously received input messages from one or more previous conversations of the user, one or more previously generated outputs from one or more previous conversations of the user, a profile of the user, personalization information associated with the user, a location of the user or of the client device used by the user, or one or more properties of the client device, an expected user satisfaction, wherein the expected user satisfaction includes one or more of a received quantification of user satisfaction of the user and a measured quantification of user satisfaction of the user, wherein the measured quantification of user satisfaction of the user is determined based on one or more behaviors of the user, an expected short term profitability, an expected long term profitability, wherein the expected long term profitability is configured to account for both short term profitability and long term behavioral changes.

In some implementations, the method further includes determining a user interaction pertaining to a respective digital content item of the one or more digital content items.

In some implementations, the method further includes determining, for each digital content item of the one or more digital content items, a respective score based on one or more respective user interactions, wherein selecting a subset of the one or more digital content items is based on the respective scores of the one or more digital content items.

In some implementations, the method further includes determining that there is a break in the output while the AI system waits for a next input message, determining one or more updated keywords based on an output received before the break, the output including one or more pauses, generating one or more updated digital components corresponding to the one or more updated keywords, and incorporating the one or more updated digital components into the conversation at a location corresponding to the determined break for display on the user interface.

In some implementations, parsing the at least one of the input message and the output is performed as light weight parsing.

In some implementations, at least one of determining the one or more keywords based on at least one of the input message and the output and generating the one or more digital components based on the one or more keywords is performed in response to one of receiving, as part of the conversation, the input message from the user, and receiving, as part of the conversation, the output generated by the AI system.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

Particular embodiments of the subject matter described in this specification can be implemented so as to realize one or more of the following advantages. The techniques discussed in this specification can improve the generating of digital components for a conversation between a user and an AI system so that the conversation can be augmented with the digital components. This can improve user engagement based on the conversation. For example, augmented conversations or portions of a conversation can be provided with one or more digital components that are relevant to the conversation or portions of the conversation. The digital components may help to further enrich the conversation and to provide visualization, enrichment, and interaction options for a user. The digital components can be generated in an organic way as the conversation progresses, for example, corresponding to user input or output generated by the AI system. In particular, output generated by the AI system can be provided in an intermittent manner rather than continuously or in one piece. The processing specificities of the intermittent output can be used to provide, in correspondence of partial outputs provided by the AI system in succession, respective one or more digital components. Based on the techniques described in this specification, the generating of digital components can be performed in a manner that does not add additional latency and or waiting time to the regular progress of the conversation. Augmenting the conversation with digital components can be performed in the same or substantially similar time as the regular progress of the conversation.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which generating digital components for a conversation between a user and an AI system can be performed.

FIG. 2 shows an example portion of a conversation between a user and an AI system.

FIG. 3 is a flow chart of an example method for generating digital components for a conversation between a user and an AI system.

FIG. 4 shows an example portion of an augmented conversation between a user and an AI system.

FIG. 5 is a block diagram of an example computer system 400 that can be used to perform the method described with respect to FIG. 3.

Like reference numbers and designations in the various drawings indicate like elements.

### DETAILED DESCRIPTION

This specification describes techniques for generating digital components for a conversation between a user and an artificial intelligence (AI) system, for example a generative AI system or a “chat bot”. The digital components can be generated by a processing system, for example, a system parsing at least parts of the conversation and generating digital components based on the parsing, or by another AI system generating output based on at least parts of the conversation and generating the digital components based on the output.

AI generally refers to the theory and development of computer systems that are capable of performing tasks that traditionally would have required human intelligence. Tasks can include, for example, visual perception, speech recognition, decision-making, and natural language processing. AI systems can utilize machine learning, for example, by using algorithms and statistical models to analyze and draw inferences from patterns and structure of training data, enabling AI systems to generate new data that has similar characteristics. Generative AI refers to AI systems capable of generating text, images, or other content in response to user input or “prompts”.

The techniques described throughout this specification enable a processing system (e.g., an AI system) to generate digital components for a conversation between a user and another, for example generative, AI system. The processing system can include, for example, a search engine, a digital component server, a reservation system, an assistant system that assists the user with personal or professional tasks, a chat bot (standalone or embedded in another service), or interaction system that interacts with users through a combination of text and rich content. When a user interacts with an AI system, in particular a generative AI system, the AI system's responses to the user input are often limited to textual output. In some implementations, the AI system is configured to generate textual output that corresponds to natural language so that a user can easily read and understand the content as the user would in another conversation, for example, in a conversation with another user. It may be beneficial to augment the textual output for the purpose of, for example, visualization, interaction, and/or other purposes. For example, augmented textual output can provide additional clarification to the users as to what the output of the AI system or chat bot refers to. This is particularly useful when a user is not familiar with language specific to a certain domain, for example, when a user who doesn't have a particular interest in jewelry and who isn't familiar with the names of stones, cuts, types of jewelry, etc., would like a recommendation regarding jewelry as a present. In yet another example, augmented text can assist in improving user experience and/or engagement, in particular while chat bot output is generated over time and sent/output to a user's device. These and further examples are described below.

An AI system typically utilizes an input prompt to a language model, such as a large language model (LLM), that outputs one or more clauses in the form of textual output in response to user input, such as a “prompt”. In the context of AI, a prompt typically refers to user input in the form of text, spoken language, or other form that communicates a user's question or query to the AI system. The particular output from the AI system in response to a user input varies based on, for example, how the user input is phrased. The AI system's processing often exhibits a processing delay while generating output and/or exhibits intermittent output, for example, including pauses between successive clauses. Successive clauses can also be referred to as partial output, or intra-processing output. One or more successive clause or partial outputs typically form a complete output of the AI system, generated in response to a prompt. In some situations, the response to a user input or prompt can be considered a complete output when the AI system is no longer generating output responsive to the user input or prompt.

The delay and/or pauses in an AI system's output can be utilized to do processing of available information, in particular “lightweight” processing. Lightweight processing can refer to non-resource intensive processing, such as simple parsing of textual information and/or the application of a simple model. Available information to process can include, for example, the user input or prompt, one or more clauses or partial output(s), and/or complete output, as well as previously received prompts and/or output (e.g., in the form of a conversation's context or “state”). The processing can be performed, for example, in order to augment, enhance, annotate, or otherwise process the prompts, clauses, partial outputs, complete output, and/or context. The processing may be configured to be performed partly or entirely during the AI system's generating of the complete output. This can entail the effect that there is a very small or no delay to the provision or display of the (augmented) complete output.

The processing may be performed by an AI system that utilizes one or more clauses or partial input in connection with a corresponding model that is configured to provide output based on which the one or more clauses or partial input, or the complete output, can be annotated. Such corresponding models can be lightweight or simple models, specialized models, or general-purpose models.

While the AI system and/or the underlying models utilized in the (lightweight) processing can be stateless, they can alternatively be context-sensitive to the overall conversation (e.g. enabling the processing of a “stateful” conversation). For example, the processing can take into account a current context of the conversation, in which the processing is at least in part based on information about a current state of the conversation. This can include taking into account the textual content of one or more previous prompts and/or that of one or more previous outputs, to be utilized in processing the one or more clauses or partial output(s). An output of the AI system doing the (lightweight) processing may include one or more keywords corresponding to the one or more clauses or partial output(s). Context-sensitive processing of a (stateful) conversation may improve the annotation of the conversation, for example, in terms of accuracy and/or completeness.

The (lightweight) processing can additionally or alternatively be based on parsing the one or more clauses or partial output, for example, to determine one or more keywords corresponding to the one or more clauses or partial output. The parsing can be optimized for light-weight processing of the one or more clauses or partial output(s) either individually or taking into account an overall context of the conversation (“stateful” conversation). Context-sensitive parsing may further improve the annotation of the conversation, for example, in terms of accuracy and/or completeness.

In some implementations, in order to augment the output, the AI system gathers information from various sources, for example, web pages or other online resources, and combines the gathered information in different ways to create different candidate digital components. The AI system uses the one or more clauses or partial output(s) to generate one or more digital components corresponding to the one or more clauses or partial output. In some examples, the generating of the one or more digital components corresponding to the one or more clauses or partial output can include determining one or more keywords and determining the one or more digital components based on the determined one or more keywords.

The AI system can further perform post-processing to select, from among the one or more digital components, which can be regarded as candidate digital components, one or more digital components to be used for annotation of the conversation. The one or more digital components can be provided for output, for example for display on a user interface.

In some implementations, the (generative) AI system is configured to generate, in response to a user's prompts, textual output that corresponds to natural language so that the user can easily read and understand the content as the user would in another conversation, for example in a conversation with another user. The textual output is then augmented for the purpose of, for example, visualization and/or interaction.

In some implementations, visualization includes retrieving digital components including digital content or digital information (e.g., a video clip, audio clip, multimedia clip, gaming content, image, text, bullet point, artificial intelligence output, language model output, or another unit of content) relevant to the conversation for introducing one or more of the retrieved digital components into the conversation for display. Digital content/information relevant to a conversation may include one or more of, for example, products/services listings, paid or unpaid, such as items a user may be interested in purchasing, places the user may be interested in making reservations for, services the user may be interested in procuring, or other products and services, especially those the providers of the products or services is interested in promoting. The one or more digital components can be displayed in combination with or near a user input and/or an AI system clause or output, or be displayed as an integrated portion of a user input and/or an AI system clause or output. Displaying the one or more digital components includes displaying of the respective digital content or digital information and further associated elements, for example, one or more captions, hyperlinks, and/or icons.

In some implementations, interaction includes the provision of interactive digital components that a user can interact with. Interactive digital components can include digital content or digital information that are associated with one or more actions, including accessing a hyperlink, launching an app or application, executing a user device-related function, or with performing another action.

In some implementations, the (generative) AI system is configured to generate the textual output intermittently over a period of time, in which the AI system generates an initial output for display and, during the period of time, successively generates additional output for display until it determines that the textual output in response to the user input is complete. Additional output can, for example, be appended to previously generated output. Typically, the AI system does not process additional user input (e.g. one or more prompts) during the period of time in which output is continuously or intermittently generated and displayed. In some implementations, the AI system is configured to buffer additional user input that is received while output in response to a previous user input is being generated.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

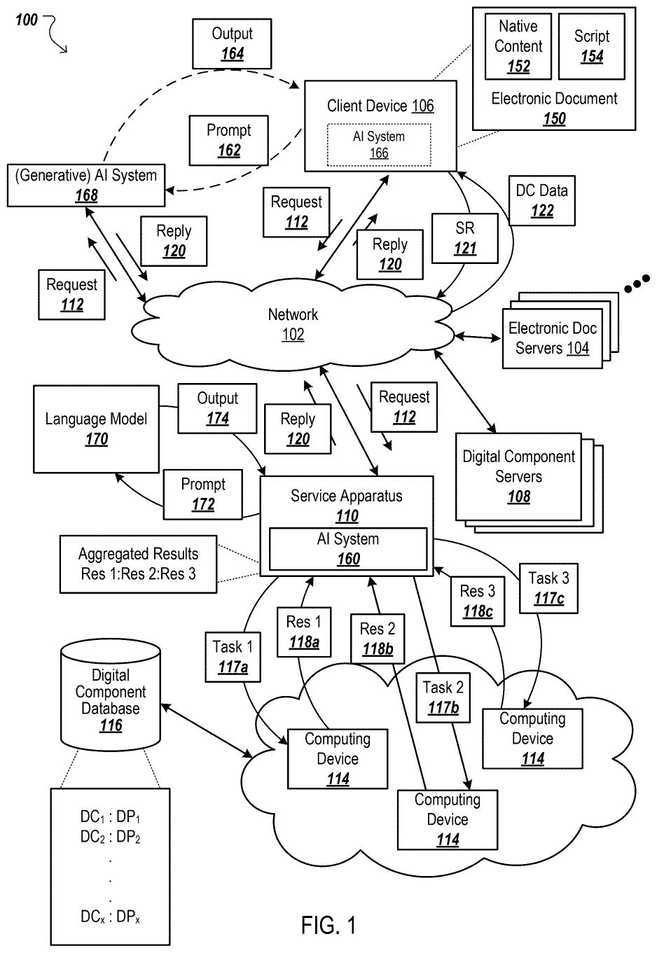

FIG. 1 is a block diagram of an example environment 100 in which generating digital components for a conversation 200 between a user and an AI system 168 can be performed. The example environment 100 includes a network 102, such as a local area network (LAN), a wide area network (WAN), the Internet, or a combination thereof. The network 102 connects electronic document servers 104, user devices 106, digital component servers 108, and a service apparatus 110. The example environment 100 may include many different electronic document servers 104, user devices 106, and digital component servers 108.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is in data communication with an AI system 168 over the network 102. The AI system 168 can be a generative AI system. The client device 106 is configured to receive prompts or user input, for example, textual input via a user interface, and to send the prompt or user input 162 to the AI system 168 (see, e.g., requests 112 sent via the network 102 from the client device 106 to the AI system 168). The requests include the user input (or prompt) 162.

The AI system 168 is configured to receive the user input 162 and to generate output 164 based on the received user input 162. The output 164 is transmitted to the client device 106 over the network 102 (see, e.g., replies 120 sent via the network 102 from the AI system 168 to the client device 106). The replies 120 include one or more clauses or partial output (e.g. part of a complete output) or a complete output generated by the AI system 168. The replies 120 are transmitted to the client device 106 over the network 102. For example, one or more replies 120 can include one or more clauses or partial outputs, or a complete output.

The AI system 168 is configured to provide the prompt or user input 162 to a language model, such as an LLM, that provides an output 164 in response to the prompt or user input 162. The output can be textual output that includes, for example, one or more clauses. The AI system 168 processes prompts 162 and generates output 164. Generating the output can entail a processing delay in that the output 164 is provided intermittently in the form of one or more clauses or partial outputs rather than continuously (e.g. as a continuous data stream) or instantaneously (e.g. as one block of data). The output 164 can include pauses between successive clauses or partial outputs while the AI system generates one or more additional clauses. One or more successive clauses or partial outputs typically form a complete output of the AI system to a prompt or user input. The output is regarded as “complete” in that it represents an AI system's response to a prompt (e.g., the AI system is no longer generating additional clauses to respond to the prompt). Once the complete output is provided by the AI system, the AI system is typically configured to wait for a next prompt.

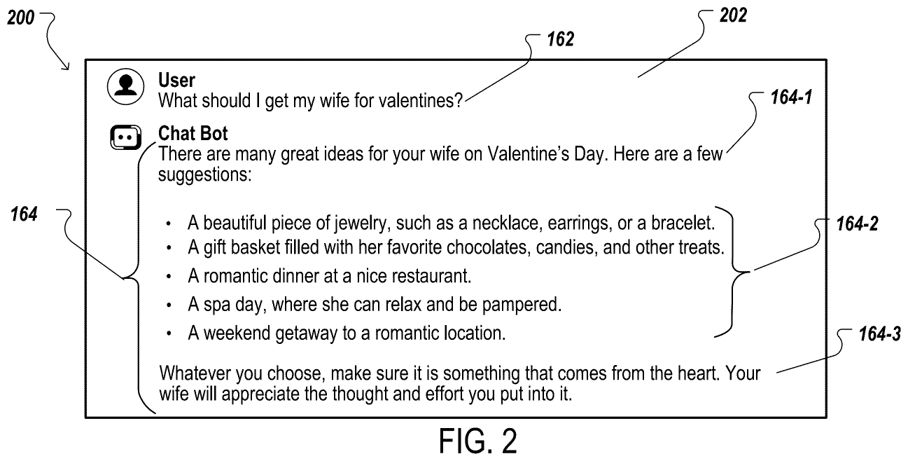

FIG. 2 shows an example portion 202 of a conversation 200 between a user and an AI system 168. The user provides a prompt 162 to the AI system 168 and the AI system 168 provides output 164 in response. As described above, the output 164 can be provided in a discrete manner as a complete output 164 or intermittently in the form of several successively provided clauses or partial outputs 164-1, 164-2, and 164-3, for example with a pause after each partial output. In a similar manner, in turn, the itemized list of partial output 164-2 may include successively provided clauses, each clause corresponding to one item in the itemized list.

A processing system, for example the AI system 166 as shown in FIG. 1, can be configured to perform processing during a time period in which the AI system 168 generates an output in response to a prompt. The processing system can be configured to incorporate into the conversation, digital components that the processing system generates. The AI system 166 can be referred to as “processing AI system” and the AI system 168 can be referred to as “generative AI system”.

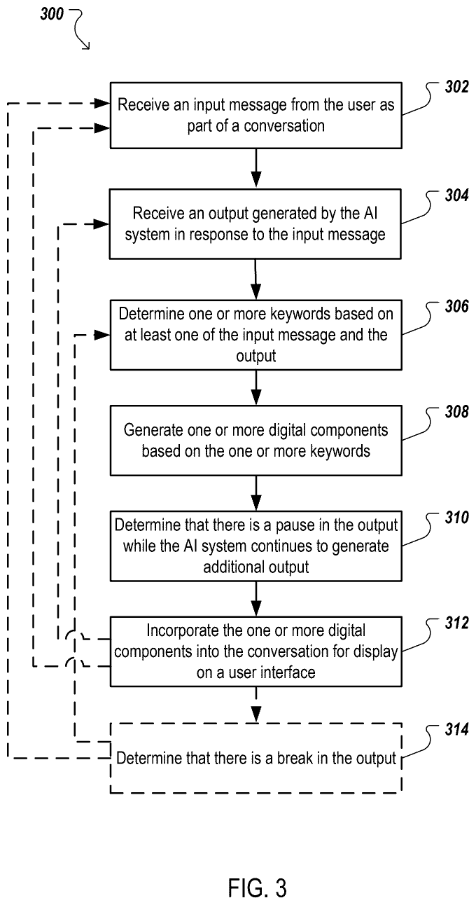

FIG. 3 is a flow chart of an example method 300 for generating digital components for a conversation between a user and an AI system. In some implementations, the method is performed by a processing system integrated into or running on the client device 106 and in communication with the AI system 168.

The processing system can include an AI system 166 as shown in FIG. 1. In other implementations, the method is performed by a processing system running independently from the client device 106. The processing is in communication with both the client device 106 and the AI system 168. The processing system can be implemented by a service apparatus 110 as shown in FIG. 1. In the following, the method 300 is described, without prejudice, as being performed by a processing system integrated into the client device 106 and employing an AI system 166.

At step 302, the AI system 166 receives an input message (e.g. a prompt 162) from a user. In some implementations, the input message is input by a user, as part of a conversation 200 between the user and an AI system 168, by using a user interface of the client device 106. The user input can include, for example, textual input from the user. The user can use any form of input supported by the client device 106, for example, keyboard input, voice input, gesture input, and other forms. The AI system 166 or the client device 106 can be configured to send the input message 162 to the AI system 168 for processing.

At step 304, the AI system 166 receives, as part of the conversation 200, an output 164 generated by the AI system 168 in response to the input message 162. In some implementations, the AI system 168 utilizes an LLM to generate, in response to the input message 162, textual output in the form of one or more clauses.

In case the LLM successively generates an intermittent series of clauses or partial outputs, for example, including pauses in between successive clauses or partial outputs, the AI system 166 successively receives output from the AI system 168 in the form of several clauses or partial outputs, for example clauses or partial outputs 164-1, 164-2, and 164-3 as shown in FIG. 2. One or more successive clauses or partial outputs 164-1, 164-2, and 164-3 typically form an output 164 of the AI system 168 in response to a prompt or input message 162.

At step 306, the AI system 166 determines one or more keywords based on at least one of the input message 162 received at step 302 and/or output 164 received at step 304. The output 164 can include one or more clauses 164-1, 164-2, and 164-3 as generated by the AI system 168.

In some implementations, the AI system 166 is configured to determine one or more updated keywords in response to receiving further output 164 from AI system 168 and/or further user input 162. This allows the AI system 166 to determine the one or more keywords based on a larger amount information. This can improve the quality of the one or more keywords. In the example conversation 200 shown in FIG. 2, if the AI system 166 determines one or more keywords solely based on the prompt 162, the context in which the AI system 166 can determine the one or more keywords is relatively limited. Similar considerations apply to a situation in which the AI system 166 determines the one or more keywords based on the prompt 162 and clause 164-1. Keywords thus determined may be relatively more general and loosely related to the conversation at hand.

Generally, the more information or context is available to the AI system 166 for determining the one or more keywords, the better the one or more keywords correspond to the conversation. In the example conversation 200 shown in FIG. 2, if the AI system 166 can determine the one or more keywords based on the prompt 162 and clauses 164-1 and 164-2, the context in which the AI system 166 can determine the one or more keywords is relatively richer than if the AI system 166 were to determine the one or more keywords solely based on the prompt 162 and/or clause 164-1. In some implementations, the context can include one or more of the following in addition to the prompt 162 and/or clause(s) 164-1: one or more previously received input messages, one or more previously generated outputs, one or more previously received input messages from a previous conversation of the user, one or more previously generated outputs from a previous conversation of the user, one or more previously received input messages from one or more previous conversations of the user, one or more previously generated outputs from one or more previous conversations of the user, a profile of the user, personalization information associated with the user, a location of the user or of a client device used by the user, and one or more properties of the client device. The user profile can include one or more of the following: information shared by the user, information inferred based on usage data of the user (e.g., demographics, interests, likes, previous commercial and non-commercial activity). The personalization information may include, in particular, information about commercial and non-commercial personalization.

At step 308, the AI system 166 generates one or more digital components 161 based on the one or more keywords. Each digital component 161 is determined based on the one or more keywords or based on a subset of the one or more keywords. In some implementations, the AI system 166 applies the one or more keywords to a simple model to generate the one or more digital components. Additionally or alternatively, the AI system can send a request 112 to a service apparatus 110 in order to query a digital components database 116, as shown in FIG. 1. Additionally or alternatively, the AI system 166 can send a request 112 to one or more digital component servers 108, one or more electronic document servers 104, and/or other servers, over the network 102 as shown in FIG. 1. The AI server 166 receives, in response to the request or requests 112, corresponding replies 120 including one or more digital components matching the query or queries.

At step 310, the AI system 166 determines that there is a pause in the output 164 received from the AI system 168. A pause can be determined as, for example, a semantic pause and/or as a delay-based pause. A semantic pause can be identified by (simple) parsing of the output. For example, a period or semicolon ending a sentence (or other punctuation mark, which can be referred to as an “output pause token”) can indicate a semantic pause. The same applies to, for example, a line break (either in general or after a bullet point) or other formatting-related character or code, a bullet point or numerator, and other printable or non-printable character encodings. In other examples, more complex parsing can be employed in order to identify a semantic pause within which the digital components could be inserted before continuing the output from the AI system. A pause can further be determined as a delay-based pause exhibiting a delay in output while further output is expected, for example, when the AI system 168 is expected to continue to generate additional output. Generally, the AI system 168 generates output 164 including one or more pauses, during which the AI system 168 temporarily pauses providing further output. During a pause in providing output, the AI system 168 continues processing the input message 162.

Once the AI system 168 generates further output 164, it resumes providing the further output after the pause. In some implementations, each of the one or more pauses has a duration of a fraction of a second (e.g., ranging from 0.1 sec to less than 1.0 sec) or a duration of one or more seconds. In some implementations, semantic pauses can trigger a delay in the output while the AI system 168 continues to generate further output. This can help improve the overall responsiveness of the AI system 168. In some implementations each of the one or more pauses can have a different duration. In some implementations, the generated output includes breaks, after which the AI system 168 does not generate further output and awaits one or more further prompts or input messages. The AI system 168 can indicate a break (denoting that a most recent output is complete), for example, with an “end of output” token (e.g. a predetermined printable or non-printable character encoding).

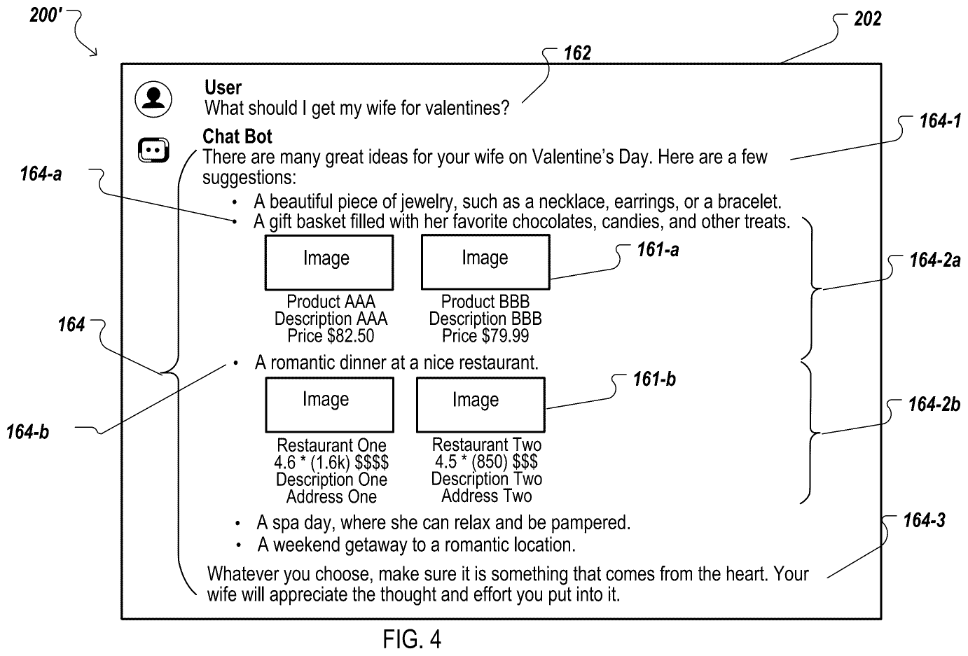

At step 312, the AI system 166 incorporates the one or more digital components 161 into the conversation 200 for display on the user interface. FIG. 4 shows an example portion of an augmented conversation 200′ between the user and the AI system 168, with the one or more digital components 161 (see digital components 161-a and 161-b) incorporated into the conversation 200. As shown, the AI system 166 determines one or more keywords based on the clause or partial output 164-a and generates, based on the one or more keywords corresponding to the clause or partial output 164-a digital components 161-a. The AI system 166 incorporates the generated one or more digital components 161-a into the conversation 200, referred to as augmented conversation 200′ in FIG. 4, for display on the user interface.

The generated digital components 161-a relate to the clause or partial output 164-a and are incorporated into the conversation 200′ in close proximity to the clause or partial output 164-a so that at least a portion of the conversation 200′ is augmented with respect to the clause or partial output 164-a. In a similar manner, the generated digital components 161-b relate to the clause or partial output 164-b and are incorporated into the conversation 200′ in close proximity to the clause or partial output 164-b so that at least a portion of the conversation 200′ is augmented with respect to the clause or partial output 164-b. In some implementations, incorporating the one or more digital components 161 (see, e.g., digital components 161-a and 161-b) into the conversation 200 in close proximity to the respective clause or partial output 164-a and 164-b includes incorporating the one or more digital components 161 into the conversation 200 directly before or after the respective clause or partial output 164-a and 164-b or directly adjacent to the clause or partial output 164-a and 164-b. In the example shown in FIG. 4, the digital components 161-a and 161-b have been incorporated into the conversation 200′ directly after the clauses or partial outputs 164-a and 164-b, respectively, for display immediately below the clauses or partial outputs 164-a and 164-b.

It may be beneficial to augment the textual output for the purpose of, for example, visualization and/or interaction. In the example shown in FIG. 4, the digital components 161-a visualize the clause or partial output 164-a and facilitate further interaction based on the digital components 161-a. In some implementations, the digital components include snippets, photos, hyperlinks, etc. For example, the digital components 161 can include one or more of the following, bounded by a box, and linking to a destination: text can include one or more of a title, a representation of the URL the link will go to, descriptions, and other callouts, an image, a video, a price, an indication that a promotion is in effect for what is mentioned, and other information helping a user understand what the digital component refers to and why they may be interested. The digital components 161 can refer to, for example, (1) a product, such as an item of jewelry (see, e.g., element 161-a in FIG. 4), a specific vehicle, an item of clothing, an item of home goods, a food or beverage item, or any other product, (2) a product category, such as a type of jewelry (e.g., “studs”, “diamond studs”), a type of vehicle (e.g., “n-row suv, sedan, compact”, model, model and year, model and year and trim), a type of clothing (e.g., “shirts”, “dress shirts”, “dress shirts with interesting prints”), (3) a physical location, such as a restaurant (see, e.g., element 161-b in FIG. 4), a store, a medical service provider (e.g., doctor, dentist, hospital), other service provider (e.g., hair salon or barber, accountant, law office), entertainment (e.g., theater, amusement park, zoo), (4) a brand, website, chain, firm, artist, sports team, (5) a service. A service can be, for example, (i) a bookable, purchasable, transactable service (see, e.g., (3) or (4); e.g., insurance services, restaurant reservations, entertainment tickets, event at a venue), (ii) travel accommodations, flight reservations, transportation services or other travel related services, (iii) an ongoing service or service that is typically provided over a longer period of time (e.g., tax consultation, legal services), (iv) virtual services (e.g., cloud services, subscriptions), or any other services.

Generally, the AI system 166 is configured to determine one or more keywords based on a first output 164 received from the AI system 168, irrespective of whether the received output 164 is a complete output or a partial output (e.g. partial outputs 164-1, 164-2, and 164-3). This entails the effect that the AI system 166 can determine the one or more keyword based on already received output 164 while the AI system 166 waits for further output 164 generated by the AI system 168.

In some implementations, the AI system 166 is configured to determine one or more keywords based on the input message 162 in response to receiving the input message 162 at step 302. This entails the effect that the AI system 166 can determine the one or more keyword corresponding to the input message 162 while the AI system 166 is waiting for output 164 generated by the AI system 168.

In some implementations, the AI system 166 determines one or more selected keywords from the one or more keywords determined based on the received input message 162 and one or more keywords determined based on one or more received outputs 164-n received from the AI system 168.

In some implementations, a latency exhibited by the AI system 168 while generating output 164 as well as pauses and/or breaks are utilized be the AI system 166 to generate one or more digital components 161 so that the AI system 166 generates the one or more digital components 161 while the AI system 168 continues to generate additional output and/or during a pause before the AI system 168 continues to generate additional output. This can entail that system performance is increased and/or a response time is reduced.

Again with reference to FIG. 3, in some implementations, after performing step 312, the AI system 166 optionally proceeds with step 302 or 204, or continues to step 314. Once the AI system 166 incorporates the one or more digital components into the conversation 200, the AI system 166 can receive (further) output 164 generated by the AI system 168, or a further input message 162 from a user. In some implementations, the AI system 166 is configured to prioritize further output provided by the AI system 168 over a further input message from the user, in which case it will proceed with step 304. The AI system 166 can be configured to buffer further input messages from the user until a break in the output is determined (see step 314). In some implementations, the AI system 166 takes the further input messages into account (e.g. the further input messages are added to the context) while performing steps 304 et seq., without providing the further input messages to the AI system 168. This entails the effect that the AI system 166 can perform step 306 based on further output 164 generated by the AI system 168 as well as further input messages from the user, which can enrich the context in which step 306 is performed.

At optional step 314, the AI system 166 determines that there is a break in output from the AI system 168 so that the AI system 166 can continue at step 306, for example, if most recent output from the AI system 168 has been received but has not been processed yet. Alternatively, the AI system 166 continues at step 302, awaiting a further input message from the user.

The conversation can be a “stateful” conversation. A “state” of a conversation can be maintained, for example, as one or more of the following: a textual summary of the conversation so far (whether from a current session or including previous sessions between the user and the AI system 168), structured input storage (e.g., digital components 161 presented so far, digital components 161 the user has reacted positively/negatively to), a score of the user's response to a digital component 161, “conceptual embedding” of the conversation so far (e.g., a learned multidimensional representation of the concepts discussed so far).

In some implementations, only a subset of clauses are augmented using digital components. The number of clauses to be augmented can be limited and candidate digital components can be ranked in order to determine a corresponding limited number of candidate digital components. The ranking can be based on a respective score that is determined for each of the candidate digital components or of a subset thereof. For example, a decision regarding how many pauses or breaks trigger a presentation of digital components can be made based on a rule-based approach or on a modelling-based approach. In a rule-based approach, e.g., a maximum number or fraction of pauses within a conversational turn or breaks within a session is determined to receive digital components 161. In another example, a higher maximum number or fraction of pauses/breaks is determined to receive digital components 161. The rules can be adjusted or adapted based on data collected about user behavior and/or response. In other examples the user research can be based on live experiments or other methods to maximize user satisfaction, an observation of user behavior (e.g., tendency to continue interacting with the AI system 168 or tendency to keep interacting with the digital components 161). In a modelling-based approach, user satisfaction is improved, optimized, or maximized based on, for example, a quality of the digital components 161. In this manner, for example, a greater number of pauses or breaks that are determined to receive digital components 161 can be allowed if those digital components 161 are more likely to cause user an improvement in satisfaction and/or if those digital components 161 exhibit a particular property (e.g. higher likelihood of interaction).

In some implementations, the client device 106 is configured to provide additional functionality, for example, presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app, and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 determines or generates digital components 161 (e.g., third-party content, such as video files, audio files, images, text, gaming content, augmented reality content, and combinations thereof, which can all take the form of advertising content or non-advertising content) that will be incorporated into conversations in response to receiving the component request 112 and/or using information included in the component request 112. In some implementations, the method 300 is performed by the service apparatus 110 and/or the AI system 160, with the client device 106 primarily serving as a user interface for receiving prompts and displaying conversations. Additionally, the digital components 161 generated by service apparatus 110 can be presented with the given electronic document (e.g., at a location specified by the script 154).

In some implementations, a digital component 161 is selected in less than a second to avoid errors that could be caused by delayed selection of the digital component. For example, delays in providing digital components in response to a component request 112 can result in delays in displaying the (augmented) conversation 200, 200′. In other examples, delays in providing digital components in response to a component request 112 can result in page load errors at the client device 106 or cause portions of the electronic document to remain unpopulated even after other portions of the electronic document are presented at the client device 106.

Also, as a delay in incorporating the one or more digital components 161 into the conversation 200 increases, it is more likely that the delay will negatively impact the flow of conversation, thereby negatively impacting a user's experience with the AI system 168. The service apparatus 110, the AI system 160, the client device 106, and/or the AI system 166 are configured to process prompts 162 and output 164 in a manner that does not add any delay in the regular processing of the conversation by the AI system 168. Additionally, an increased delay in providing a digital component 161 to the client device 106 may lead to the electronic document no longer being presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the service apparatus 110 is implemented in a distributed computing system that includes, for example, a server and a set of multiple computing devices 114 that are interconnected and identify and distribute digital component in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the one or more digital components 161 can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data. In some implementations, selecting the subset of the one or more digital content items is based on a combination of one or more of (a) a measure of relevance of one or more of: the input message, the output, the one or more previously received input messages, the one or more previously generated outputs, the one or more previously received input messages from a previous conversation of the user, the one or more previously generated outputs from a previous conversation of the user, the one or more previously received input messages from one or more previous conversations of the user, the one or more previously generated outputs from one or more previous conversations of the user, the profile of the user, the personalization information associated with the user, the location of the user or of the client device used by the user, and the one or more properties of the client device, (b) an expected user satisfaction, wherein the expected user satisfaction includes one or more of a received quantification of user satisfaction of the user and a measured quantification of user satisfaction of the user, wherein the measured quantification of user satisfaction of the user is determined based on one or more behaviors of the user, (c) an expected short term profitability (e.g., over a specified time period, such as a day, week, or month), and (d) an expected long term profitability (e.g., beyond the specified time period). The expected long-term profitability is configured to account for both short-term profitability and long term behavioral changes.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data (DC Data) 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlaid over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

In some implementations, the service apparatus 110 includes the AI system 160, which is configured to perform the method 300 as described above. The AI system 160 is configured to autonomously generate digital components, either prior to a request 112 (e.g., offline) and/or in response to a request 112 (e.g., online or real-time). As described in more detail throughout this specification, the artificial intelligence (“AI”) system 160 can collect online content about a specific entity (e.g., digital component provider or another entity) and summarize the collected online content using one or more language models 170, which can include large language models.

A large language model (LLM) is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chat bots that can have conversations with humans; and generate creative text, such as poems, stories, and code.

The language model 170 can be any appropriate language model neural network that receives an input sequence made up of text tokens selected from a vocabulary and auto-regressively generates an output sequence made up of text tokens from the vocabulary. For example, the language model 170 can be a Transformer-based language model neural network or a recurrent neural network-based language model.

In some situations, the language model 170 can be referred to as an auto-regressive neural network when the neural network used to implement the language model 170 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model 170 can process the current input sequence to generate a score distribution, e.g., a probability distribution, that assigns a respective score, e.g., a respective probability, to each token in the vocabulary of tokens. The neural network of the language model 170 can then select, as the particular token, a token from the vocabulary using the score distribution. For example, the neural network of the language model 170 can greedily select the highest-scoring token or can sample, e.g., using nucleus sampling or another sampling technique, a token from the distribution.

As a particular example, the language model 170 can be an auto-regressive Transformer-based neural network that includes (i) a plurality of attention blocks that each apply a self-attention operation and (ii) an output subnetwork that processes an output of the last attention block to generate the score distribution.

The language model 170 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same language model 170 to generate multiple different candidate output sequences in response to the same request, e.g., by using beam search decoding from score distributions generated by the language model 170, using a Sample-and-Rank decoding strategy, by using different random seeds for the pseudo-random number generator that's used in sampling for different runs through the language model 170 or using another decoding strategy that leverages the auto-regressive nature of the language model.

In some implementations, the language model 170 is pre-trained, i.e., trained on a language modeling task that does not require providing evidence in response to user questions, and the service apparatus 110 (e.g., using AI system 160) causes the language model 170 to generate output sequences according to the pre-determined syntax through natural language prompts in the input sequence.

For example, the service apparatus 110 (e.g., AI system 160), or a separate training system, pre-trains the language model 170 (e.g., the neural network) on a language modeling task, e.g., a task that requires predicting, given a current sequence of text tokens, the next token that follows the current sequence in the training data. As a particular example, the language model 170 can be pre-trained on a maximum-likelihood objective on a large dataset of text, e.g., text that is publicly available from the Internet or another text corpus.

In some implementations, method 300 as described above is performed by the AI system 160. In such implementations, the client device 106 primarily provides a user interface for interactions between the user and the AI system 168. The prompts 162 and output 164 are relayed via service apparatus 110, which employs the AI system 160 as described above with respect to the AI system 166 running on the client device 106. In some implementations, the client 106 includes a basic renderer in which the client includes, for example, a web browser. In such cases, the service apparatus 110 creates a webpage that contains the augmented AI system 168 response, which can be progressively updated (e.g., using AJAX) as in the user interface shown in FIGS. 2 and 4. In the alternative, the client 106 includes a chat client, in which case the service apparatus 110 can send both (partial) output from the AI system 168 and messages containing the digital components 161. In some implementations, the client 106 can include a simple client with no AI functionality, but running logic (e.g., a web browser running JavaScript that can parse output from the AI system 168). Such a client 106 can include logic that determines when to request digital components 161 and that requests corresponding digital components 161. In some implementations, the client 106 includes a full system, for example, an app that runs complex logic and/or an AI system.

Performing the method 300 using the AI system 160 can entail the effect that more system resources can be provided by service apparatus 110 to run the AI system 160 in comparison to those or the client device 106 running the AI system 166. The AI system 160 can, thus, apply more complex and/or comprehensive models and/or can be trained based on more comprehensive training data or training data that is not available to the AI system 166 employed by the client device 106. Additionally or alternatively, the service system 110 and/or the AI system 160 can have access to more network resources for generating digital components 161 and/or may locally maintain a library of pre-processed or cached digital components for reuse during processing of one or more conversations.

The AI system 160 can perform one or more post-processing operations that evaluate one or more characteristics of the multiple candidate digital components. The post-processing operations can also include an evaluation of the relevance of the clauses to the query constraint, a level of completeness of the clauses relative to content located at the link included in the candidate digital component, and/or an evaluation of the tone (e.g., positive or negative) of the clause. Post-processing operations can be used to score, or otherwise assign a level of priority to, each of the candidate digital components so that the AI system 160 can rank the multiple candidate digital components relative to each other, and ultimately serve one or more of the highest ranking candidate digital components as output digital components as a reply 120 to the request 112. Note that, although the operations of the AI system 160 and language model 170 are described above as being performed responsive to receipt of the request 112, at least some of the operations can be performed prior to receipt of the request 112.

Furthermore, although a single language model 170 is shown in FIG. 1, different language models can be specially trained to process different prompts at different stages of the processing pipeline. For example, a more general (e.g., larger) language model can be used to generate the summaries of online content as an offline process (e.g., independent of receipt of the request 112), which can then be inserted into prompts that are input to a more specialized and faster language model in an online process (e.g., real-time in response to receiving the request 112. Additionally, the AI system 160 can generate a set of candidate digital components as an offline process (e.g., prior to receiving the request 112, and store the set of candidate digital components in a database. In this scenario, when the AI system 160 receives the request 112, the AI system 160 can further evaluate and rank the stored candidate digital components based on additional information included in the request and other contextual data (e.g., time of day, day of week, weather conditions, etc.).

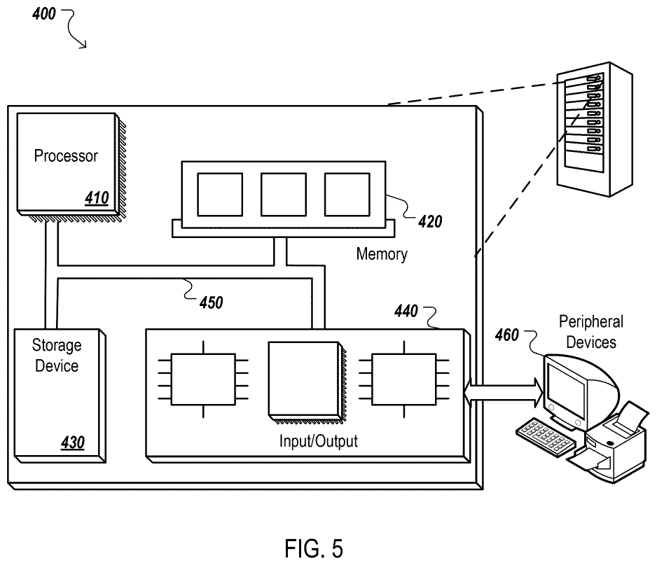

FIG. 5 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 460. Other implementations, however, can also be used, such as mobile computing devices, mobile communication devices, set-top box television client devices, etc.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method for generating digital components for a conversation between a user and an artificial intelligence (AI) system employing a language model, the method comprising:
receiving, as part of the conversation, an input message from the user;
receiving, as part of the conversation, an output generated by the AI system in response to the input message and based on the language model;
determining one or more keywords based on at least one of the input message and the output;
generating one or more digital components based on the one or more keywords;
determining that there is a pause in the output while the AI system continues to generate additional output; and
incorporating the one or more digital components into the conversation at a location corresponding to the determined pause for display on a user interface.

2. The method of claim 1, wherein generating the one or more digital components based on the one or more keywords further comprises:
sending the one or more keywords to a processing system; and
receiving, from the processing system, the one or more digital components.

3. The method of claim 1, wherein determining the one or more keywords based on at least one of the input message and the output comprises parsing the at least one of the input message and the output.

4. The method of claim 1, wherein determining the one or more keywords is further based on one or more of: the input message, the output, one or more previously received input messages, one or more previously generated outputs, one or more previously received input messages from a previous conversation of the user, one or more previously generated outputs from a previous conversation of the user, one or more previously received input messages from one or more previous conversations of the user, one or more previously generated outputs from one or more previous conversations of the user, a profile of the user, personalization information associated with the user, a location of the user or of a client device used by the user, or one or more properties of the client device.

5. The method of claim 1, wherein the output comprises a plurality of text items and wherein determining the one or more keywords comprises determining, for each text item in the plurality of text items, at least one keyword.

6. The method of claim 1, wherein the processing system comprises one or more of a search engine, a digital component server, a reservation system, an assistant system that assists the user with tasks, or a chat bot.

7. The method of claim 1, further comprising displaying, on the user interface, the conversation and the one or more digital components.

8. The method of claim 1, wherein generating the one or more digital components based on the one or more keywords comprises separately generating each digital component of the one or more digital components based on at least a subset of the one or more keywords.

9. The method of claim 1, further comprising selecting a subset of the one or more digital content items; and wherein incorporating the one or more digital components into the conversation comprises incorporating the subset of the one or more digital content items into the conversation.

10. (canceled)

11. (canceled)

12. (canceled)

13. The method of claim 1, further comprising:
determining that there is a break in the output while the AI system waits for a next input message;
determining one or more updated keywords based on an output received before the break, the output including one or more pauses;
generating one or more updated digital components corresponding to the one or more updated keywords; and
incorporating the one or more updated digital components into the conversation at a location corresponding to the determined break for display on the user interface.

14. (canceled)

15. The method of claim 1, wherein at least one of determining the one or more keywords based on at least one of the input message and the output and generating the one or more digital components based on the one or more keywords is performed in response to one of receiving, as part of the conversation, the input message from the user, and receiving, as part of the conversation, the output generated by the AI system.

16. A system for generating digital components for a conversation between a user and an artificial intelligence (AI) system employing a language model, comprising:
a data storage device; and
one or more processors configured to interact with the data storage device and perform, upon execution of instructions, operations comprising
receiving, as part of the conversation, an input message from the user,
receiving, as part of the conversation, an output generated by the AI system in response to the input message and based on the language model,
determining one or more keywords based on at least one of the input message and the output,
generating one or more digital components based on the one or more keywords,
determining that there is a pause in the output while the AI system continues to generate additional output, and
incorporating the one or more digital components into the conversation at a location corresponding to the determined pause for display on a user interface.

17. (canceled)

18. The system of claim 16, wherein determining the one or more keywords based on at least one of the input message and the output comprises parsing the at least one of the input message and the output.

19. The system of claim 16, wherein determining the one or more keywords is further based on one or more of: the input message, the output, one or more previously received input messages, one or more previously generated outputs, one or more previously received input messages from a previous conversation of the user, one or more previously generated outputs from a previous conversation of the user, one or more previously received input messages from one or more previous conversations of the user, one or more previously generated outputs from one or more previous conversations of the user, a profile of the user, personalization information associated with the user, a location of the user or of a client device used by the user, or one or more properties of the client device.

20. The system of claim 16, wherein the output comprises a plurality of text items and wherein determining the one or more keywords comprises determining, for each text item in the plurality of text items, at least one keyword.

21. The system of claim 16, wherein the processing system comprises one or more of a search engine, a digital component server, a reservation system, an assistant system that assists the user with tasks, or a chat bot.

22. The system of claim 16, further comprising displaying, on the user interface, the conversation and the one or more digital components.

23. The system of claim 16, wherein generating the one or more digital components based on the one or more keywords comprises separately generating each digital component of the one or more digital components based on at least a subset of the one or more keywords.

24. The system of claim 16, wherein the operations further comprise selecting a subset of the one or more digital content items; and wherein incorporating the one or more digital components into the conversation comprises incorporating the subset of the one or more digital content items into the conversation.

25. (canceled)

26. (canceled)

27. (canceled)

28. The system of claim 16, wherein the operations further comprise:
determining that there is a break in the output while the AI system waits for a next input message;
determining one or more updated keywords based on an output received before the break, the output including one or more pauses;
generating one or more updated digital components corresponding to the one or more updated keywords; and
incorporating the one or more updated digital components into the conversation at a location corresponding to the determined break for display on the user interface.

29. (canceled)

30. The system of claim 16, wherein at least one of determining the one or more keywords based on at least one of the input message and the output and generating the one or more digital components based on the one or more keywords is performed in response to one of receiving, as part of the conversation, the input message from the user, and receiving, as part of the conversation, the output generated by the AI system.

31. A non-transitory computer readable medium storing instructions for generating digital components for a conversation between a user and an artificial intelligence (AI) system employing a language model, wherein the instructions, upon execution, cause one or more processors to perform operations comprising
receiving, as part of the conversation, an input message from the user,
receiving, as part of the conversation, an output generated by the AI system in response to the input message and based on the language model,
determining one or more keywords based on at least one of the input message and the output,
generating one or more digital components based on the one or more keywords,
determining that there is a pause in the output while the AI system continues to generate additional output, and
incorporating the one or more digital components into the conversation at a location corresponding to the determined pause for display on a user interface.

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. The non-transitory computer readable medium of claim 31, wherein the operations further comprise:
determining that there is a break in the output while the AI system waits for a next input message;
determining one or more updated keywords based on an output received before the break, the output including one or more pauses;
generating one or more updated digital components corresponding to the one or more updated keywords; and
incorporating the one or more updated digital components into the conversation at a location corresponding to the determined break for display on the user interface.

44. (canceled)

45. (canceled)
